(19) United States
(12) Patent Application Publication
(10) Pub. No.: US 2020/0320462 A1
(43) Pub. Date: Oct. 8, 2020

(54) CALCULATING ONLINE SOCIAL NETWORK DISTANCE BETWEEN ENTITIES OF AN ORGANIZATION

(71) Applicant: International Business Machines Corporation, Armonk, NY (US)

(72) Inventors: Dakuo Wang, Cambridge, MA (US); Chuang Gan, Cambridge, MA (US); Michael Muller, Medford, MA (US); Zijun Wang, White Plains, NY (US); Daniel M. Gruen, Newton, MA (US)

(21) Appl. No.: 16/374,398

(22) Filed: Apr. 3, 2019

(51) Int. Cl. G06Q 10/06; G06Q 50/00; G06N 20/00

(52) U.S. Cl. CPC G06Q 10/063118; G06N 20/00; G06Q 50/01

(57) ABSTRACT

Systems, computer-implemented methods, and computer program products that can facilitate calculating an online social network distance between entities of an organization are provided. According to an embodiment, a system can comprise a memory that stores computer executable components and a processor that executes the computer executable components stored in the memory. The computer executable components can comprise a weighted organizational distance component that calculates a weighted organizational distance score of one or more links between entities of an organization hierarchy based on directionality of the one or more links relative to the organization hierarchy. The computer executable components can further comprise a learner component that employs an artificial intelligence model to generate information based on the weighted organizational distance score.

### BACKGROUND

The subject disclosure relates to calculating online social network distance between entities of a network, and more specifically, to calculating an online social network distance between entities of an organization hierarchy.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that can facilitate calculating an online social network distance between entities of an organization are described.

According to an embodiment, a system can comprise a memory that stores computer executable components and a processor that executes the computer executable components stored in the memory. The computer executable components can comprise a weighted organizational distance component that calculates a weighted organizational distance score of one or more links between entities of an organization hierarchy based on directionality of the one or more links relative to the organization hierarchy. The computer executable components can further comprise a learner component that employs an artificial intelligence model to generate information based on the weighted organizational distance score.

According to another embodiment, a computer-implemented method can comprise calculating, by a system operatively coupled to a processor, a weighted organizational distance score of one or more links between entities of an organization hierarchy based on directionality of the one or more links relative to the organization hierarchy. The computer-implemented method can further comprise employing, by the system, an artificial intelligence model to generate information based on the weighted organizational distance score.

According to another embodiment, a computer program product facilitating calculation of an online social network distance between entities of an organization is provided. The computer program product comprising a computer readable storage medium having program instructions embodied therewith, the program instructions executable by a processor to cause the processor to calculate, by the processor, a weighted organizational distance score of one or more links between entities of an organization hierarchy based on directionality of the one or more links relative to the organization hierarchy. The program instructions are further executable by the processor to cause the processor to employ, by the processor, an artificial intelligence model to generate information based on the weighted organizational distance score.

### DESCRIPTION OF THE DRAWINGS

FIG. 1 illustrates a block diagram of an example, non-limiting system that can facilitate calculating an online social network distance between entities of an organization in accordance with one or more embodiments described herein.

FIG. 2 illustrates example, non-limiting organization charts that can facilitate calculating an online social network distance between entities of an organization in accordance with one or more embodiments described herein.

FIG. 3 illustrates an example, non-limiting table that can facilitate calculating an online social network distance between entities of an organization in accordance with one or more embodiments described herein.

FIG. 4 illustrates a block diagram of an example, non-limiting system that can facilitate calculating an online social network distance between entities of an organization in accordance with one or more embodiments described herein.

FIG. 5 illustrates a block diagram of an example, non-limiting system that can facilitate calculating an online social network distance between entities of an organization in accordance with one or more embodiments described herein.

FIG. 6 illustrates a block diagram of an example, non-limiting system that can facilitate calculating an online social network distance between entities of an organization in accordance with one or more embodiments described herein.

FIG. 7 illustrates a flow diagram of an example, non-limiting computer-implemented method that can facilitate calculating an online social network distance between entities of an organization in accordance with one or more embodiments described herein.

FIG. 8 illustrates a flow diagram of an example, non-limiting computer-implemented method that can facilitate calculating an online social network distance between entities of an organization in accordance with one or more embodiments described herein.

FIG. 9 illustrates a flow diagram of an example, non-limiting computer-implemented method that can facilitate calculating an online social network distance between entities of an organization in accordance with one or more embodiments described herein.

FIG. 10 illustrates a block diagram of an example, non-limiting operating environment in which one or more embodiments described herein can be facilitated.

FIG. 11 illustrates a block diagram of an example, non-limiting cloud computing environment in accordance with one or more embodiments of the subject disclosure.

FIG. 12 illustrates a block diagram of example, non-limiting abstraction model layers in accordance with one or more embodiments of the subject disclosure.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

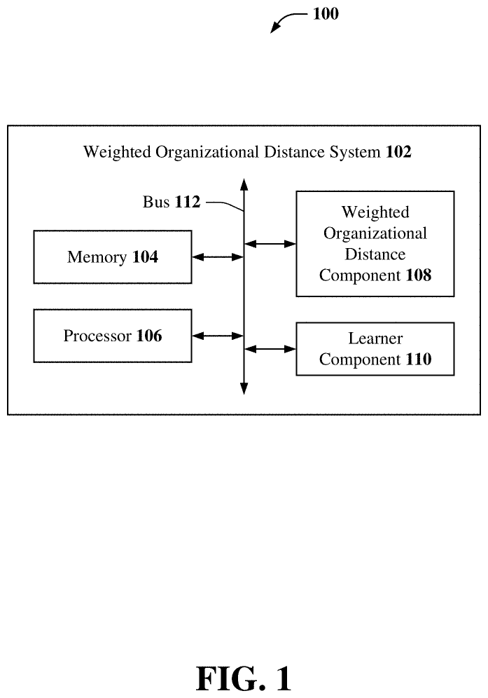

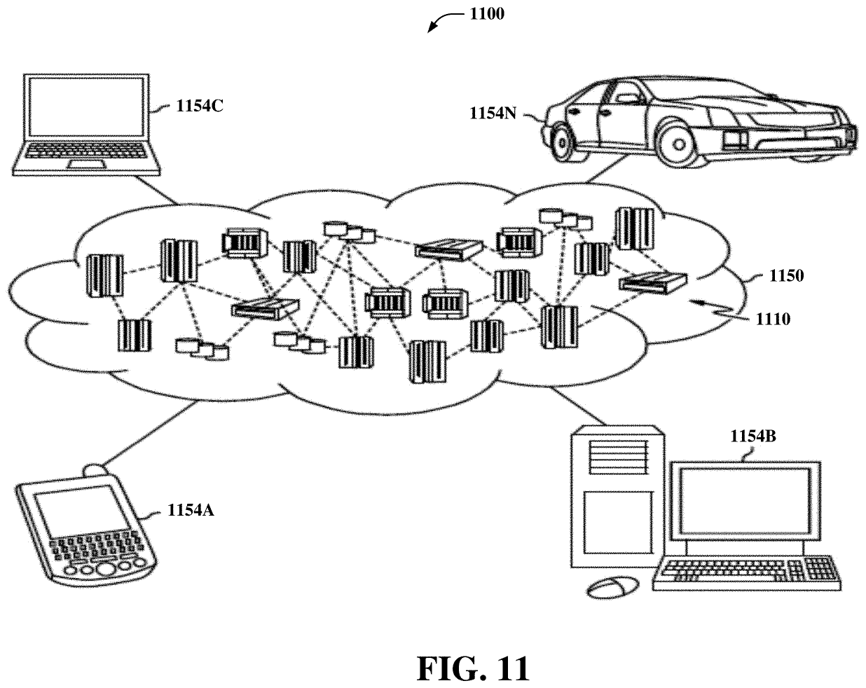

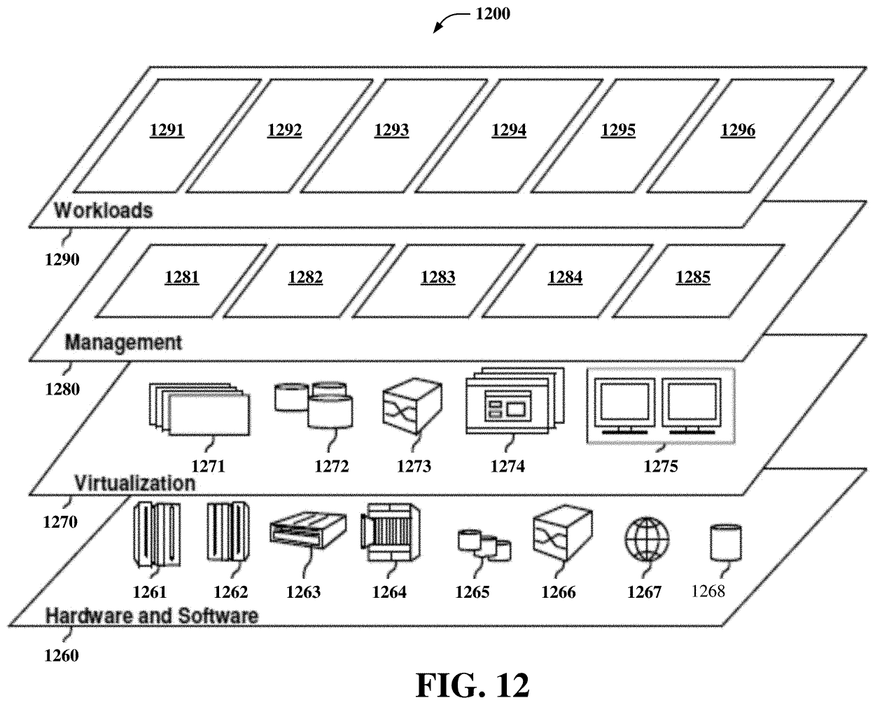

FIG. 1 illustrates a block diagram of an example, non-limiting system 100 that can facilitate calculating an online social network distance between entities of an organization in accordance with one or more embodiments described herein. In some embodiments, system 100 can comprise a weighted organizational distance system 102. In some embodiments, weighted organizational distance system 102 can be associated with a cloud computing environment. For example, weighted organizational distance system 102 can be associated with cloud computing environment 1150 described below with reference to FIG. 11 and/or one or more functional abstraction layers described below with reference to FIG. 12 (e.g., hardware and software layer 1260, virtualization layer 1270, management layer 1280, and/or workloads layer 1290).

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models are as Follows

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Continuing now with FIG. 1, according to several embodiments, system 100 can comprise weighted organizational distance system 102. In some embodiments, weighted organizational distance system 102 can comprise a memory 104, a processor 106, a weighted organizational distance component 108, a learner component 110, and/or a bus 112.

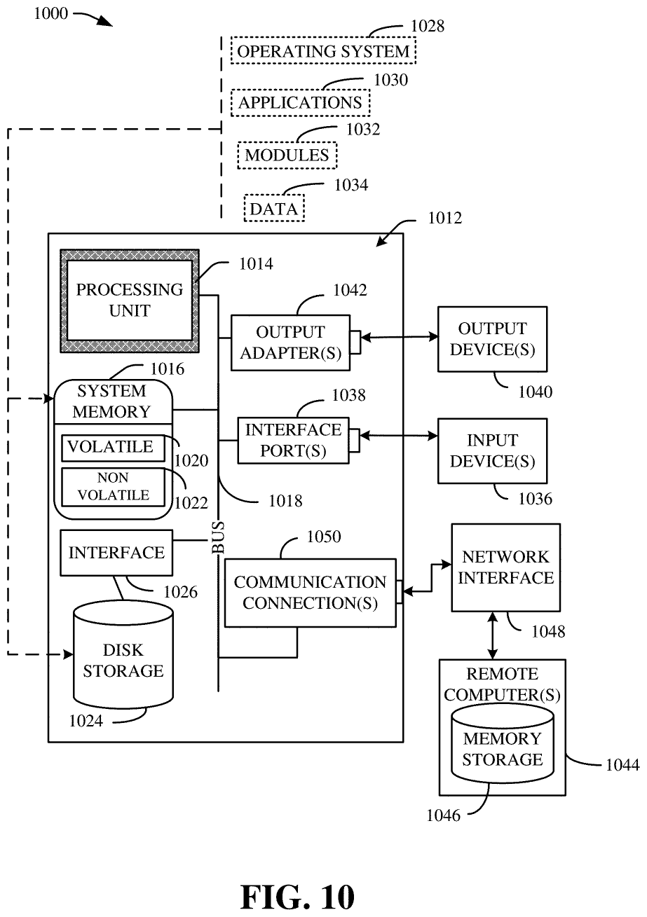

It should be appreciated that the embodiments of the subject disclosure depicted in various figures disclosed herein are for illustration only, and as such, the architecture of such embodiments are not limited to the systems, devices, or components depicted therein. For example, in some embodiments, system 100 and/or weighted organizational distance system 102 can further comprise various computer or computing-based elements described herein with reference to operating environment 1000 and FIG. 10. In several embodiments, such computer or computing-based elements can be used in connection with implementing one or more of the systems, devices, components, or computer-implemented operations shown and described in connection with FIG. 1 or other figures disclosed herein.

According to multiple embodiments, memory 104 can store one or more computer or machine readable, writable, or executable components or instructions that, when executed by processor 106, can facilitate performance of operations defined by the executable component(s) or instruction(s). For example, memory 104 can store computer or machine readable, writable, or executable components or instructions that, when executed by processor 106, can facilitate execution of the various functions described herein relating to weighted organizational distance system 102, weighted organizational distance component 108, learner component 110, and/or another component associated with weighted organizational distance system 102, as described herein with or without reference to the various figures of the subject disclosure.

In some embodiments, memory 104 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 104 are described below with reference to system memory 1016 and FIG. 10. Such examples of memory 104 can be employed to implement any embodiments of the subject disclosure.

According to multiple embodiments, processor 106 can comprise one or more types of processors or electronic circuitry that can implement one or more computer and/or machine readable, writable, and/or executable components and/or instructions that can be stored on memory 104. For example, processor 106 can perform various operations that can be specified by such computer and/or machine readable, writable, and/or executable components and/or instructions including, but not limited to, logic, control, input/output (I/O), arithmetic, and/or the like. In some embodiments, processor 106 can comprise one or more central processing unit, multi-core processor, microprocessor, dual microprocessors, microcontroller, System on a Chip (SOC), array processor, vector processor, and/or another type of processor. Further examples of processor 106 are described below with reference to processing unit 1014 and FIG. 10. Such examples of processor 106 can be employed to implement any embodiments of the subject disclosure.

In some embodiments, weighted organizational distance system 102, memory 104, processor 106, weighted organizational distance component 108, learner component 110, and/or another component of weighted organizational distance system 102 as described herein can be communicatively, electrically, and/or operatively coupled to one another via a bus 112 to perform functions of system 100, weighted organizational distance system 102, and/or any components coupled therewith. In several embodiments, bus 112 can comprise one or more memory bus, memory controller, peripheral bus, external bus, local bus, and/or another type of bus that can employ various bus architectures. Further examples of bus 112 are described below with reference to system bus 1018 and FIG. 10. Such examples of bus 112 can be employed to implement any embodiments of the subject disclosure.

According to multiple embodiments, weighted organizational distance system 102 can comprise any type of component, machine, device, facility, apparatus, and/or instrument that comprises a processor and/or can be capable of effective and/or operative communication with a wired and/or wireless network. All such embodiments are envisioned. For example, weighted organizational distance system 102 can comprise a server device, a computing device, a general-purpose computer, a special-purpose computer, a quantum computing device (e.g., a quantum computer, a quantum processor, etc.), a tablet computing device, a handheld device, a server class computing machine and/or database, a laptop computer, a notebook computer, a desktop computer, a cell phone, a smart phone, a consumer appliance and/or instrumentation, an industrial and/or commercial device, a digital assistant, a multimedia Internet enabled phone, a multimedia players, and/or another type of device.

In some embodiments, weighted organizational distance system 102 can be coupled (e.g., communicatively, electrically, operatively, etc.) to one or more external systems, sources, and/or devices (e.g., computing devices, communication devices, etc.) via a data cable (e.g., High-Definition Multimedia Interface (HDMI), recommended standard (RS) 232, Ethernet cable, etc.). In some embodiments, weighted organizational distance system 102 can be coupled (e.g., communicatively, electrically, operatively, etc.) to one or more external systems, sources, and/or devices (e.g., computing devices, communication devices, etc.) via a network.

According to multiple embodiments, such a network can comprise wired and/or wireless networks, including, but not limited to, a cellular network, a wide area network (WAN) (e.g., the Internet), and/or a local area network (LAN). For example, weighted organizational distance system 102 can communicate with one or more external systems, sources, and/or devices, for instance, computing devices (and vice versa) using virtually any desired wired or wireless technology, including but not limited to: wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Zigbee and other 802.XX wireless technologies or legacy telecommunication technologies, BLUETOOTH®, Session Initiation Protocol (SIP), ZIGBEE®, RF4CE protocol, WirelessHART protocol, 6LoWPAN (IPv6 over Low power Wireless Area Networks), Z-Wave, an ANT, an ultra-wideband (UWB) standard protocol, and/or other proprietary and non-proprietary communication protocols. In such an example, weighted organizational distance system 102 can thus include hardware (e.g., a central processing unit (CPU), a transceiver, a decoder), software (e.g., a set of threads, a set of processes, software in execution) and/or a combination of hardware and software that facilitates communicating information between weighted organizational distance system 102 and external systems, sources, and/or devices (e.g., computing devices, communication devices, etc.).

In some embodiments, weighted organizational distance system 102 can comprise one or more computer and/or machine readable, writable, and/or executable components and/or instructions that, when executed by processor 106, can facilitate performance of operations defined by such component(s) and/or instruction(s). Further, in some embodiments, any component associated with weighted organizational distance system 102, as described herein with or without reference to the various figures of the subject disclosure, can comprise one or more computer and/or machine readable, writable, and/or executable components and/or instructions that, when executed by processor 106, can facilitate performance of operations defined by such component(s) and/or instruction(s). For example, weighted organizational distance component 108, learner component 110, and/or any other components associated with weighted organizational distance system 102 as disclosed herein (e.g., communicatively, electronically, and/or operatively coupled with or employed by weighted organizational distance system 102), can comprise such computer and/or machine readable, writable, and/or executable component(s) and/or instruction(s). Consequently, in some embodiments, weighted organizational distance system 102 and/or any components associated therewith as disclosed herein, can employ processor 106 to execute such computer and/or machine readable, writable, and/or executable component(s) and/or instruction(s) to facilitate performance of one or more operations described herein with reference to weighted organizational distance system 102 and/or any such components associated therewith.

In some embodiments, weighted organizational distance system 102 can facilitate performance of operations executed by and/or associated with weighted organizational distance component 108, learner component 110, and/or another component associated with weighted organizational distance system 102 as disclosed herein. For example, as described in detail below, weighted organizational distance system 102 can facilitate: calculating a weighted organizational distance score of one or more links between entities of an organization hierarchy based on directionality of the one or more links relative to the organization hierarchy; and/or employing an artificial intelligence model to generate information based on the weighted organizational distance score. In some embodiments, weighted organizational distance system 102 can further facilitate: calculating a weighted organizational distance score of one or more weighted links between the entities of the organization hierarchy; calculating one or more weights of the one or more links based on the directionality of the one or more links relative to the organization hierarchy; calculating a weighted organizational distance score of the one or more links or one or more weighted links between the entities of the organization hierarchy based on an entity impact score of at least one of the entities; calculating an entity impact score of at least one of the entities based on data selected from a group consisting of metadata, organizational rank, reporting chain, direct connection to one or more of the entities, a second entity impact score of a directly connected entity of the organization hierarchy, and online community activity; and/or employing the artificial intelligence model to generate at least one of an entity to entity connection recommendation, an entity assignment to a team recommendation, a team of defined entities recommendation, or a team performance prediction based on the weighted organizational distance score.

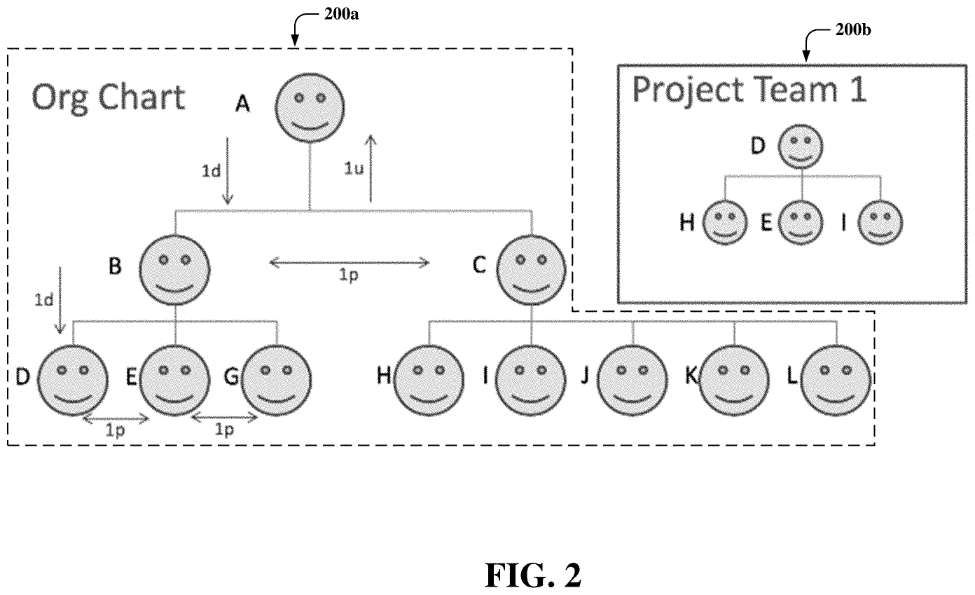

As referenced herein, an organization hierarchy can comprise an organization chart (also referred to herein and/or in the figures as an org chart) that can illustrate the structure of an organization, as well as the relationships and relative ranks of the components of the organization. For example, as referenced herein, an organization hierarchy can comprise an organization chart that can illustrate the structure of an organization, as well as the relationships and relative ranks of the people associated with the organization (also referred to herein and/or in the figures as “entities of the organization”) and/or the positions of the organization (e.g., job positions, job titles, etc.). As used herein, people associated with the organization or entities of the organization can also include people or entities employed by the organization in some embodiments. Further, as referenced herein, an organization hierarchy can comprise organization chart 200a described below and illustrated in FIG. 2.

As referenced herein, a link between entities of an organization hierarchy can describe a relationship between such entities, where in the field of data and/or graph analytics, such a link can comprise an edge and such entities can comprise nodes of, for example, a knowledge base. As referenced herein, such a link can comprise one or more discrete links (also referred to herein as steps), where such one or more discrete links (e.g., steps) can constitute a link that can connect a first entity (e.g., entity A) to a second entity (e.g., entity D) by connecting one or more other entities between the first entity and the second entity. For example, a link that can connect such an entity A to an entity D can comprise a first discrete link (e.g., a first step) that can connect entity A to an entity B, a second discrete link (e.g., a second step) that can connect entity B to an entity C, and a third discrete link (e.g., a third step) that can connect entity C to entity D.

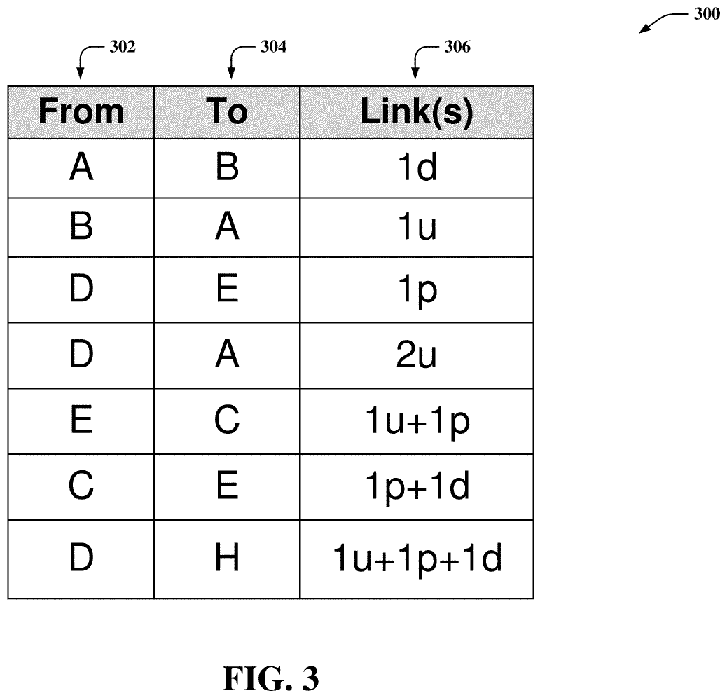

According to multiple embodiments, weighted organizational distance component 108 can calculate a weighted organizational distance score of one or more links between entities of an organization hierarchy based on directionality of the one or more links relative to the organization hierarchy. For example, weighted organizational distance component 108 can calculate a weighted organizational distance score of one or more links between two entities of an organization hierarchy (e.g., entity A and entity B) based on directionality of the one or more links relative to the organization hierarchy. In some embodiments, such directionality of the one or more links relative to the organization hierarchy can include, but is not limited to, an up direction, a down direction, a lateral direction, and/or another direction. For example, with reference to organization chart 200a described below and illustrated in FIG. 2, such directionality can comprise an up (u) direction (e.g., denoted as 1u in FIGS. 2 and 3 to represent 1 step in the up (u) direction), a down (d) direction (e.g., denoted as 1d in FIGS. 2 and 3 to represent 1 step in the down (d) direction), and/or a lateral (p) direction (e.g., denoted as 1p in FIGS. 2 and 3 to represent 1 step in the direction of a peer entity, which can constitute 1 step in the lateral (p) direction). As referenced herein, a peer entity can comprise an entity (e.g., a human etc.) that can have equal standing (e.g., equal ranking) with one or more other entities.

FIG. 2 illustrates example, non-limiting organization charts 200a, 200b that can facilitate calculating an online social network distance between entities of an organization in accordance with one or more embodiments described herein. Repetitive description of like elements and/or processes employed in respective embodiments is omitted for sake of brevity.

According to multiple embodiments, organization chart 200a (e.g., denoted as Org Chart in FIG. 2) can comprise an organization hierarchy that can comprise entities of an organization (e.g., a company, a network, a team, a group, an association, etc.). For example, organization chart 200a can comprise entities A, B, C, D, E, G, H, I, J, K, L (e.g., denoted as A, B, C, D, E, G, H, I, J, K, and L, respectively, in FIG. 2). In some embodiments, entities A, B, C, D, E, G, H, I, J, K, L can comprise, for example, people associated with an organization such as, for instance, a company.

In some embodiments, entities D, E, G, H, I, J, K, L can comprise first level entities (e.g., first level person associated with an organization, person associated with the organization having a particular or low rank, etc.), where such entities can comprise subordinate entities relative to entities B, C. For example, entities D, E, G can comprise peer entities relative to one another that can report to entity B and entities H, I, J, K, L can comprise peer entities relative to one another that can report to entity C.

In some embodiments, entities B, C can comprise second level entities (e.g., second level person associated with an organization, person associated with an organization having a defined rank such as a middle rank, etc.), where such entities can comprise peer entities relative to one another, superior entities relative to entities D, E, G, H, I, J, K, L, and/or subordinate entities relative to entity A. For example, entities B, C can comprise peer entities relative to one another that can each report to entity A. In this example, entity B can comprise a superior entity that can manage entities D, E, G and entity C can comprise a superior entity that can manage entities H, I, J, K, L.

In some embodiments, entity A can comprise a third level entity (e.g., third level person associated with an organization, person associated with an organization having a defined rank such as a high rank, etc.), where entity A can comprise a superior entity relative to entities B, C. For example, entity A can comprise a superior entity that can manage entities B, C.

According to multiple embodiments, organization chart 200b (e.g., denoted as Project Team 1 in FIG. 2) can comprise an organization hierarchy (e.g., a sub-organization hierarchy) that can comprise entities of another organization hierarchy (e.g., a primary organization hierarchy). For example, organization chart 200b can comprise a sub-organization hierarchy that can represent a project team (e.g., denoted as Project Team 1 in FIG. 2) comprising two or more entities of organization chart 200a. For instance, organization chart 200b can comprise a sub-organization hierarchy representing a project team comprising two or more entities of organization chart 200a including, but not limited to, entities D, H, E, I (e.g., denoted as D, H, E, and I, respectively, in FIG. 2).

Returning to FIG. 1, as described above, in some embodiments, weighted organizational distance component 108 can calculate a weighted organizational distance score of one or more links between entities of an organization hierarchy based on directionality of the one or more links relative to the organization hierarchy. For example, weighted organizational distance component 108 can calculate a weighted organizational distance score of one or more links between entities of organization chart 200a (and/or organization chart 200b in some embodiments) based on directionality of the one or more links relative to organization chart 200a (and/or organization chart 200b in some embodiments). For instance, weighted organizational distance component 108 can calculate a weighted organizational distance score of a link between entity A and entity B of organization chart 200a based on directionality of such a link relative to organization chart 200a. In this example, such directionality relative to organization chart 200a can depend on whether such a link begins at entity A and extends to entity B or begins at entity B and extends to entity A. In some embodiments, such directionality, relative to organization chart 200a, of a link beginning at entity A and extending to entity B can comprise a down (d) direction, for example, as described below and illustrated in FIG. 3. In some embodiments, such directionality, relative to organization chart 200a, of a link beginning at entity B and extending to entity A can comprise an up (u) direction, for example, as described below and illustrated in FIG. 3.

FIG. 3 illustrates an example, non-limiting table 300 that can facilitate calculating an online social network distance between entities of an organization in accordance with one or more embodiments described herein. Repetitive description of like elements and/or processes employed in respective embodiments is omitted for sake of brevity.

According to multiple embodiments, table 300 can comprise a from column 302, a to column 304, and/or a link(s) column 306. In some embodiments, from column 302 can comprise an entity of an organization hierarchy (e.g., organization chart 200a, organization chart 200b, etc.) at which a link can begin and extend to another entity of such an organization hierarchy. In some embodiments, to column 304 can comprise an entity of such an organization hierarchy at which such a link can end. In some embodiments, link(s) column 306 can comprise a quantity of one or more links (e.g., discrete links and/or steps as defined above). In some embodiments, link(s) column 306 can further comprise directionality of such one or more links relative to such an organization hierarchy (e.g., up (u), down (d), and/or lateral (p), denoted as d, u, and p in FIGS. 2 and 3).

In an example, with reference to organization chart 200a illustrated in FIG. 2, a link from entity A to entity B can comprise 1 down (1d) direction link. In contrast, in another example, again with reference to organization chart 200a, a link from entity B to entity A can comprise 1 up (1u) direction link. In another example, again with reference to organization chart 200a, a link from entity E to entity C can comprise 1 up (1u) direction link (e.g., 1 up (1u) direction discrete link or 1 up (1u) direction step as defined above) that can connect entity E to entity B and 1 lateral (1p) direction link (e.g., 1 lateral (1p) direction discrete link or 1 lateral (1p) direction step as defined above) that can connect entity B to entity C. In contrast, in another example, again with reference to organization chart 200a, a link from entity C to entity E can comprise 1 lateral (1p) direction link (e.g., 1 lateral (1p) direction discrete link or 1 lateral (1p) direction step as defined above) that can connect entity C to entity B and 1 down (1d) direction link (e.g., 1 down (1d) direction discrete link or 1 down (1d) direction step as defined above) that can connect entity B to entity E. In another example, again with reference to organization chart 200a, a link from entity D to entity H can comprise: 1 up (1u) direction link (e.g., 1 up (1u) direction discrete link or 1 up (1u) direction step as defined above) that can connect entity D to entity B; 1 lateral (1p) direction link (e.g., 1 lateral (1p) direction discrete link or 1 lateral (1p) direction step as defined above) that can connect entity B to entity C; and 1 down (1d) direction link (e.g., 1 down (1d) direction discrete link or 1 down (1d) direction step as defined above) that can connect entity C to entity H.

Returning to FIG. 1, although link(s) column 306 of table 300 depicted in FIG. 3 comprises links having equal weight values of 1.0 (e.g., d, u, p), it should be appreciated that the subject disclosure is not so limited. For instance, in some embodiments, to calculate a weighted organizational distance score of one or more links (e.g., discrete links or steps as defined above) between entities of an organization hierarchy based on directionality of the one or more links relative to the organization hierarchy, weighted organizational distance component 108 can facilitate assigning one or more weights to the one or more links based on directionality of such link(s). For example, weighted organizational distance component 108 can facilitate assigning a first weight to an up (u) direction link (e.g., an up (u) direction discrete link or an up (u) direction step as defined above), a second weight to a down (d) direction link (e.g., a down (d) direction discrete link or a down (d) direction step as defined above), and/or a third weight to a lateral (p) direction link (e.g., a lateral (p) direction discrete link or a lateral (p) direction step as defined above). For instance, weighted organizational distance component 108 can facilitate assigning a first weight comprising, for example, a numerical value of 1.0 or some other numerical value, to an up (u) direction link (e.g., an up (u) direction discrete link or an up (u) direction step as defined above). In another example, weighted organizational distance component 108 can facilitate assigning a second weight comprising, for instance, 2.0 or some other numerical value, to a down (d) direction link (e.g., a down (d) direction discrete link or a down (d) direction step as defined above). In another example, weighted organizational distance component 108 can facilitate assigning a third weight comprising, for instance, 3.0 or some other numerical value, to a lateral (p) direction link (e.g., a lateral (p) direction discrete link or a lateral (p) direction step as defined above).

In some embodiments, by assigning such weights (also referred to herein as directionality weights) to the one or more links based on directionality, weighted organizational distance component 108 can thereby facilitate quantifying a relationship between two entities based on, for instance, the relative positions of the entities within an organization hierarchy, where such positions can be indicative of entity ranking (e.g., manager, reporting person associated with an organization, etc.). For example, weighted organizational distance component 108 can assign a higher numerical value (e.g., 2.0) as a directional weight to a down (d) direction link and a lower numerical value (e.g., 1.0) as a directional weight to an up (u) direction link. In this example, weighted organizational distance component 108 can thereby facilitate, for instance, weighting a relationship between two entities of an organization hierarchy differently depending on whether the relationship is viewed from the vantage point of one entity (e.g., entity A) or the other entity (e.g., entity B). For instance, with reference to organization chart 200a, as weighted organizational distance component 108 can assign a higher directional weight of 2.0 to a down (d) direction link and a lower directional weight of 1.0 to an up (u) direction link, weighted organizational distance component 108 can thereby facilitate weighting a relationship as viewed from the vantage point of a manager as twice the weight of a relationship as viewed from the vantage point of a reporting person associated with an organization that reports to the manager.

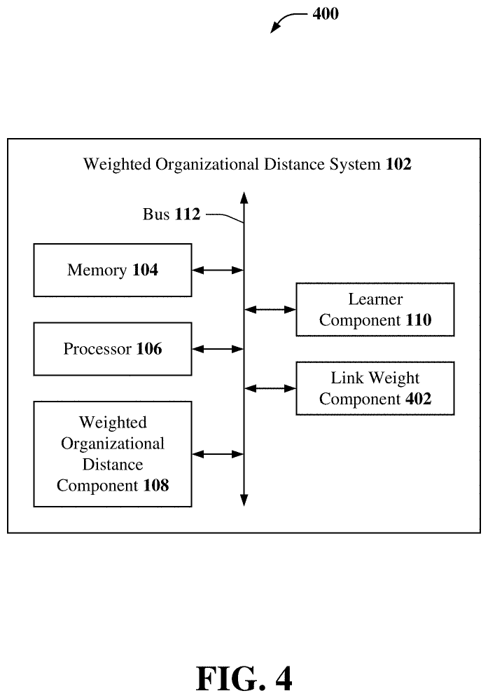

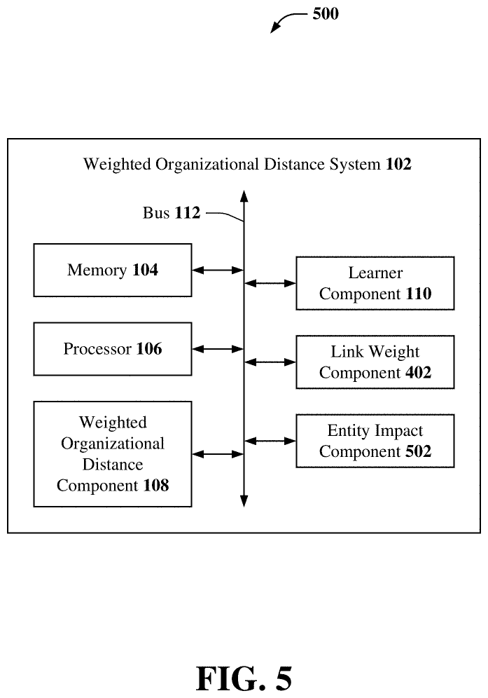

In some embodiments, weighted organizational distance component 108 can facilitate assigning such one or more directionality weights described above to the one or more links based on input received by weighted organizational distance system 102 from an entity operating weighted organizational distance system 102. For example, an entity (e.g., a human) can employ an interface component (e.g., an application programming interface (API), a graphical user interface (GUI), etc.) of weighted organizational distance system 102 (not illustrated in the figures) to define, input, and/or store in a memory (e.g., in memory 104) numerical values that can be used by weighted organizational distance component 108 to assign such directionality weights to such link(s). In this example, weighted organizational distance component 108 can receive (e.g., via an API, GUI, etc.) and/or retrieve from a memory (e.g., from memory 104 using processor 106) such defined, input, and/or stored numerical values and can further assign directional weights to the one or more links based on the numerical values using, for instance, a weighted strict hierarchical distance plus peers algorithm (also referred to herein and/or in the figures as the SHPW algorithm). For example, weighted organizational distance component 108 can employ equation (1) defined below with reference to FIG. 5 to assign such directional weights to the one or more links described above. In some embodiments, weighted organizational distance component 108 can employ link weight component 402 described below with reference to FIG. 4 to assign weights to one or more links between entities of an organization hierarchy based on directionality of such link(s) relative to the organization hierarchy.

In some embodiments, weighted organizational distance component 108 can further employ the SHPW algorithm to calculate a weighted organizational distance score of such one or more directionally weighted links described above between entities (e.g., entity D and entity H, etc.) of an organization hierarchy (e.g., organization chart 200a, organization chart 200b, etc.). In some embodiments, to facilitate calculating (e.g., via the SHPW algorithm) a weighted organizational distance score of such one or more directionally weighted links described above between entities of an organization hierarchy, weighted organizational distance component 108 can mathematically combine (e.g., sum, add, etc.) the total quantity of directionally weighted links between such entities. For example, with reference to table 300 depicted in FIG. 3, weighted organizational distance component 108 can mathematically combine (e.g., sum, add, etc.) the total quantity of directionally weighted links 1u+1p+1d between entity D and entity H of organization chart 200a. In this example, the numerical value 1 in front of the directionally weighted links u, p, and d denotes a single link in the corresponding direction (e.g., u, p, or d) and all such directionally weighted links u, p, and d, are each weighted equally as 1.0.

In some embodiments, weighted organizational distance component 108 can calculate a weighted organizational distance score of a team comprising multiple entities of an organization hierarchy based on directionality, relative to the organization hierarchy, of one or more links between one or more pairs of such entities. For example, weighted organizational distance component 108 can calculate a weighted organizational distance score of a team comprising multiple entities such as, for instance, Project Team 1 represented by organization chart 200b depicted in FIG. 2.

In some embodiments, weighted organizational distance component 108 can calculate a weighted organizational distance score of a team of entities represented by an organization hierarchy by calculating the weighted organizational distance scores of one or more links between each possible pair combination of the entities in the team. For example, weighted organizational distance component 108 can calculate a weighted organizational distance score of Project Team 1 represented by organization chart 200b by calculating the weighted organizational distance scores of one or more links between each possible pair combination of entities D, H, E, I. For instance, weighted organizational distance component 108 can calculate a weighted organizational distance score of Project Team 1 represented by organization chart 200b by calculating the weighted organizational distance scores of: the link between entity D and entity H; the link between entity D and entity E; the link between entity D and entity I; the link between entity H and entity E; the link between entity H and entity I; and the link between entity E and entity I.

In some embodiments, weighted organizational distance component 108 can calculate a weighted organizational distance score of Project Team 1 represented by organization chart 200b by mathematically combining (e.g., adding, summing, etc.) such weighted organizational distance scores (e.g., calculated as described above) of the links between such pairs of entities defined above. In some embodiments, weighted organizational distance component 108 can calculate a weighted organizational distance score of Project Team 1 represented by organization chart 200b by calculating a normalized mean (e.g., an average) of such weighted organizational distance scores (e.g., calculated as described above) of the links between such pairs of entities defined above. In some embodiments, weighted organizational distance component 108 can calculate a weighted organizational distance score of Project Team 1 represented by organization chart 200b by selecting the weighted organizational distance score having the highest value (e.g., maximum value) relative to all other such weighted organizational distance scores (e.g., calculated as described above) of the links between such pairs of entities defined above. In some embodiments, weighted organizational distance component 108 can calculate a weighted organizational distance score of Project Team 1 represented by organization chart 200b by selecting the weighted organizational distance score having the lowest value (e g , minimum value) relative to all other such weighted organizational distance scores (e.g., calculated as described above) of the links between such pairs of entities defined above.

In some embodiments, weighted organizational distance component 108 can calculate a weighted organizational distance score of one or more weighted links between entities of an organization hierarchy. For example, weighted organizational distance component 108 can calculate a weighted organizational distance score of one or more weighted links that can be weighted based on directionality relative to an organization hierarchy as described above. In another example, weighted organizational distance component 108 can calculate a weighted organizational distance score of one or more weighted links that can be weighted based on an entity impact score of at least one of the entities of an organization hierarchy, where such an entity impact score can comprise a numerical value that can be used to weight one or more links between such entities. In some embodiments, such an entity impact score can be calculated by, for example, entity impact component 502 described below with reference to FIG. 5 based on data corresponding to at least one of the entities (e.g., metadata, organizational rank, reporting chain, direct connection to one or more other entities of the organization hierarchy, an entity impact score of a directly connected entity of the organization hierarchy, online community activity, etc.).

According to multiple embodiments, learner component 110 can comprise and/or employ an artificial intelligence (AI) model to generate information based on a weighted organizational distance score. For example, learner component 110 can comprise and/or employ an AI model to generate information based on one or more of the weighted organizational distance scores that can be calculated by weighted organizational distance component 108 according to one or more embodiments of the subject disclosure as described herein. In some embodiments, learner component 110 can comprise and/or employ an AI model to generate information based on one or more of the weighted organizational distance scores that can be calculated by weighted organizational distance component 108 as described herein, where such information can include, but is not limited to, an entity to entity connection recommendation, an entity assignment to a team recommendation, a team of defined entities recommendation, a team performance prediction, and/or other information.

In some embodiments, to facilitate generating such information based on such one or more of the weighted organizational distance scores that can be calculated by weighted organizational distance component 108, learner component 110 can comprise and/or employ an artificial intelligence (AI) model and/or a machine learning (ML) model including, but not limited to, a classification model, a probabilistic model, statistical-based model, an inference-based model, a deep learning model, a neural network, long short-term memory (LSTM), fuzzy logic, expert system, Bayesian model, and/or another model that can generate such information described above based on such one or more weighted organizational distance scores that can be calculated by weighted organizational distance component 108. For example, as weighted organizational distance component 108 can calculate weighted organizational distance scores of one or more links between multiple entities of an organization hierarchy, where such link(s) can be weighted (e.g., via entity impact component 502 as described below) based on data corresponding to at least one of the entities, learner component 110 can comprise and/or employ one or more of such AI and/or ML models described above to generate information such as, for instance: a recommendation to connect a certain entity with another entity (e.g., entity D and entity L of organization chart 200a depicted in FIG. 2); a recommendation to assign a certain entity to a team (e.g., to assign entity H to Project Team 1 represented by organization chart 200b in FIG. 2); a recommendation to create a team comprising certain entities that can be defined by learner component 110 (e.g., to create Project Team 1 comprising entities D, H, E, I as illustrated in FIG. 2); a prediction of a team's performance (e.g., a prediction of Project Team 1 performance); and/or other information.

FIG. 4 illustrates a block diagram of an example, non-limiting system 400 that can facilitate calculating an online social network distance between entities of an organization in accordance with one or more embodiments described herein. In some embodiments, system 400 can comprise weighted organizational distance system 102. In some embodiments, weighted organizational distance system 102 can comprise a link weight component 402. Repetitive description of like elements and/or processes employed in respective embodiments is omitted for sake of brevity.

According to multiple embodiments, link weight component 402 can assign one or more weights to one or more links between entities of an organization hierarchy based on directionality of the one or more links relative to the organization hierarchy. For example, link weight component 402 can assign one or more weights to one or more links between entities of an organization hierarchy based on directionality of the one or more links relative to the organization hierarchy by assigning a certain weight value to each level of the organization hierarchy and further assigning such weight(s) to such link(s) based on whether such link(s) traverse one or more entities positioned on the same level of the organization hierarchy or one or more different levels of the organization hierarchy.

In some embodiments, with reference to organization chart 200a depicted in FIG. 2, link weight component 402 can assign a first weight value (e.g., a numerical value such as, for instance 1.0 or some other numerical value) to all entities D, E, G, H, I, J, K, L positioned on the first level of organization chart 200a. In some embodiments, again reference to organization chart 200a, link weight component 402 can assign a second weight value (e.g., a numerical value such as, for instance 2.0 or some other numerical value) to all entities B, C positioned on the second level of organization chart 200a. In some embodiments, again reference to organization chart 200a, link weight component 402 can assign a third weight value (e.g., a numerical value such as, for instance 3.0 or some other numerical value) to entity A positioned on the third level of organization chart 200a. In these embodiments, such assignment of such first, second, and/or third weight values as described above can enable link weight component 402 to assign one or more weights to one or more links between entities of an organization hierarchy based on directionality of the one or more links relative to the organization hierarchy by assigning such weight(s) to such link(s) based on whether such link(s) traverse one or more entities positioned on the same level of the organization hierarchy or one or more different levels of the organization hierarchy.

In some embodiments, link weight component 402 can assign one or more weights to one or more links between entities of an organization hierarchy based on directionality of the one or more links relative to the organization hierarchy by assigning such weight(s) to such link(s) using the same technique used by weighted organizational distance component 108 as described above with reference to FIGS. 1, 2, and 3. In some embodiments, link weight component 402 can assign one or more weights to one or more links between entities of an organization hierarchy based on directionality of the one or more links relative to the organization hierarchy by assigning such weight(s) to such link(s) based on an entity impact score of at least one entity of an organization hierarchy, where such an entity impact score can be calculated by, for instance, entity impact component 502 as described below with reference to FIG. 5.

FIG. 5 illustrates a block diagram of an example, non-limiting system 500 that can facilitate calculating an online social network distance between entities of an organization in accordance with one or more embodiments described herein. In some embodiments, system 500 can comprise weighted organizational distance system 102. In some embodiments, weighted organizational distance system 102 can comprise an entity impact component 502. Repetitive description of like elements and/or processes employed in respective embodiments is omitted for sake of brevity.

According to multiple embodiments, entity impact component 502 can calculate an entity impact score of at least one entity of an organization hierarchy based on data including, but not limited to: metadata; organizational rank (e.g., person associated with an organization ranking relative to other people associated with the organization, position of the entity within an organization chart, etc.); reporting chain; direct connection to one or more other entities of the organization hierarchy (e.g., direct connection to one or more peers, one or more managers, one or more reporting people associated with the organization, etc.); an entity impact score of a directly connected entity of the organization hierarchy; online community activity; and/or other data. In some embodiments, such data can comprise data that can be collected within the organization on which such an organization hierarchy is based or outside such an organization. In some embodiments, such data can comprise one or more attributes (e.g., personality traits, characteristics, interests, etc.) and/or one or more actions (e.g., electronic-mail (e-mail) transmissions, hobbies, work related activities, authoring a published article, etc.) of an entity of an organization hierarchy.

In some embodiments, such weighted organizational distance scores of one or more links between entities of an organization hierarchy that can be calculated by weighted organizational distance component 108 as described above can be affected by such data, attribute(s), and/or action(s) corresponding to such entities as defined above. For example, such data, attribute(s), and/or action(s) of a certain entity can affect one or more weights of one or more links between such an entity and another entity of an organization hierarchy, thereby affecting a weighted organizational distance score of one or more links and/or one or more weighted links between such entities. For instance, with reference to organization chart 200a illustrated in FIG. 2, such data, attribute(s), and/or action(s) of entity B can affect the weight that can be assigned to the lateral (1p) direction link to entity C. In this example, if entity B sends 5 times as many e-mail messages to entity C as entity C sends to entity B, then the weight that can be assigned to the lateral (1p) direction link as viewed from the vantage point of entity B (e.g., extending from entity B to entity C) can be greater (e.g., higher numerical value) than the weight that can be assigned to the same lateral (1p) direction link as viewed from the vantage point of entity C (e.g., extending from entity C to entity B). In another example, again with reference to organization chart 200a illustrated in FIG. 2, as entity B has 3 direct reporting connections (e.g., entities D, E, G) and entity C has 5 direct reporting connections (e.g., entities H, I, J, K, L), then the weight that can be assigned to the lateral (1p) direction link as viewed from the vantage point of entity B (e.g., extending from entity B to entity C) can be less (e.g., lower numerical value) than the weight that can be assigned to the same lateral (1p) direction link as viewed from the vantage point of entity C (e.g., extending from entity C to entity B).

In some embodiments, therefore, weighted organizational distance component 108 can calculate a weighted organizational distance score of one or more links and/or one or more weighted links between entities of an organization hierarchy based on an entity impact score of at least one of the entities, where such an entity impact score can be calculated based on such data, attribute(s), and/or action(s) defined above that correspond to at least one of the entities. For example, weighted organizational distance component 108 can calculate a weighted organizational distance score of one or more links and/or one or more weighted links between entities of an organization hierarchy based on an entity impact score of at least one of the entities that can be calculated by entity impact component 502.

In some embodiments, entity impact component 502 can calculate an entity impact score of an entity of an organization hierarchy based on an online community impact score of the entity that can represent the entity's online community activity (e.g., social network activity such as, for instance, message posts, responses to posts, etc.), where, for example, more activity can correspond to a high online community impact score and less activity can correspond to a low online community impact score. In some embodiments, entity impact component 502 can calculate an entity impact score of an entity of an organization hierarchy based on a rank impact score that can represent the entity's organizational ranking, where, for example, a high ranking can correspond to a high rank impact score and a low ranking can correspond to a low rank impact score. In some embodiments, entity impact component 502 can calculate an entity impact score of an entity of an organization hierarchy based on a direct connection score of such an entity that can represent the quantity of entities directly connected to such an entity in an organization hierarchy, where, for example, a high quantity of direct connections can correspond to a high direct connection score and a low quantity of direct connections can correspond to a low direct connection score. In some embodiments, entity impact component 502 can calculate an entity impact score of an entity of an organization hierarchy by mathematically combining (e.g., adding, summing, etc.) the online community impact score, the rank score, and/or the direct connection score (e.g., calculated as described above) into a single score that can constitute the entity impact score. In some embodiments, such online community impact score, rank score, direct connection score, and/or entity impact score can constitute feature metrics corresponding to an entity of an organization hierarchy, where such feature metrics can be used to calculate a weighted organizational distance score of one or more links and/or one or more weighted links between entities of an organization hierarchy as described below with reference to equation (1).

In some embodiments, based on weighted organizational distance component 108 mathematically combining (e.g., summing, adding, etc.) the total quantity of directionally weighted links (e.g., 1u+1p+1d) between a pair of entities as described above with reference to FIG. 1, weighted organizational distance component 108 and/or entity impact component 502 can employ a machine learning (ML) model such as, for instance, a convolutional neural network (CNN) model to calculate hyper-parameters and/or weights of features based on such data, attribute(s), and/or action(s) defined above that correspond to at least one of the entities.

In some embodiments, for example, where an organization hierarchy as described herein comprises an organization chart of a company and the entities of such an organization chart comprise people associated with the company, weighted organizational distance component 108 and/or entity impact component 502 can employ data collection component 602 to collect, for instance, one or more evaluations of a person associated with the organization (e.g., performance evaluations, etc.) corresponding to each person associated with the organization of a pair of people associated with the organization. In these embodiments, such evaluations can comprise multidimensional metrics (e.g., features vector) that can constitute feature metrics, which can have features including, but not limited to, business impact, client success, and/or another feature. In these embodiments, weighted organizational distance component 108 and/or entity impact component 502 can further employ data collection component 602 to collect, for instance, information corresponding to each person associated with the organization of a pair of people associated with the organization and relating to project assignments of each person associated with the organization (e.g., list of projects each person associated with the organization is assigned to, project success scores, awards granted to the person associated with the organization based on project achievements, papers and/or articles published based on the work of the project team, etc.). In these embodiments, weighted organizational distance component 108 and/or entity impact component 502 can input to a CNN model the total quantity of directionally weighted links (e.g., 1u+1p+1d) between the pair of people associated with the organization and/or the evaluation of the person associated with the organization and described above to output from such a CNN model one or more project outcomes (e.g., based on the project information described above). In these embodiments, based on historical data, weighted organizational distance component 108 and/or entity impact component 502 can employ CNN model to optimize the loss function to determine a desired value (e.g., acceptable value within a predefined range of acceptable values) of Beta, Theta, u, d, and p, using equation (1) defined below.

Project_Outcome=Beta*(Person Associated with the Organization_N Feature Metric)+Theta* (uN+dM+pR) Equation (1)

where N, M, and R denote constant numbers.

In the embodiments described above, based on determining desired (e.g., acceptable) values of u, d, and p using equation (1) defined above, weighted organizational distance component 108 can calculate a weighted organizational distance score of one or more links and/or one or more weighted links between any pair of people associated with the organization in the organization chart of the company. In some embodiments, learner component 110 can employ such CNN model and/or equation (1) defined above to generate information comprising project performance prediction (e.g., Project_Outcome of equation (1) defined above).

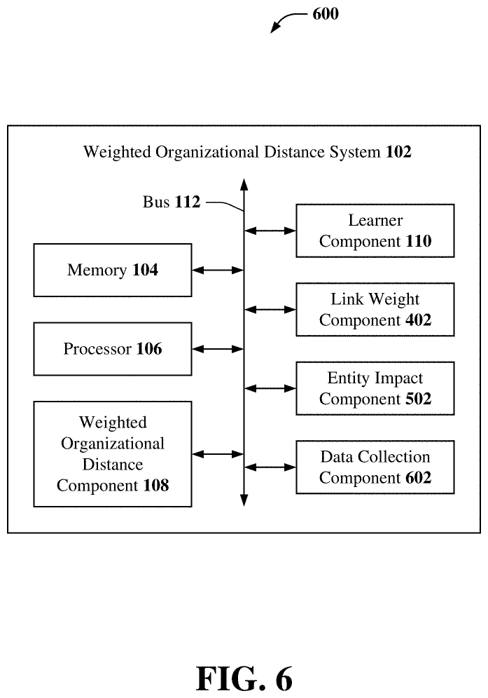

FIG. 6 illustrates a block diagram of an example, non-limiting system 600 that can facilitate calculating an online social network distance between entities of an organization in accordance with one or more embodiments described herein. In some embodiments, system 600 can comprise weighted organizational distance system 102. In some embodiments, weighted organizational distance system 102 can comprise a data collection component 602. Repetitive description of like elements and/or processes employed in respective embodiments is omitted for sake of brevity.

According to multiple embodiments, data collection component 602 can collect data corresponding to one or more entities of an organization hierarchy. For example, data collection component 602 can collect data corresponding to such one or more entities of an organization hierarchy, where such data can comprise the data defined above that can be used by entity impact component 502 to calculate an entity impact score, an online community impact score, a rank score, and/or a direct connection score of an entity (e.g., calculated as described above).

In some embodiments, data collection component 602 can comprise and/or employ an artificial intelligence (AI) model and/or a machine learning (ML) model to collect (e.g., extract) such data described above from various data sources accessible on a network (e.g., the Internet, an intranet of a company, a database, etc.). In some embodiments, data collection component 602 can store (e.g., via processor 106) collected data on a memory (e.g., memory 104) where it can be retrieved and/or used by any components of weighted organizational distance system 102 (e.g., weighted organizational distance component 108, learner component 110, link weight component 402, entity impact component 502, etc.).

In some embodiments, data collection component 602 can comprise and/or employ an AI and/or a ML model including, but not limited to, a classification model, a probabilistic model, statistical-based model, an inference-based model, a deep learning model, a neural network, long short-term memory (LSTM), fuzzy logic, expert system, Bayesian model, and/or another model that can extract such data described above from such data sources. For example, data collection component 602 can comprise and/or employ an AI model that can utilize, for instance, long short-term memory (LSTM), a reasoning algorithm, natural language annotation, and/or natural language processing (NLP) to extract such data described above from such data sources. In some embodiments, data collection component 602 can collect such data described above from such data sources by executing read and/or write operations using processor 106 to read such data from a data source and/or write such data to a memory (e.g., memory 104) where it can be retrieved and/or used by any components of weighted organizational distance system 102 (e.g., weighted organizational distance component 108, learner component 110, link weight component 402, entity impact component 502, etc.).

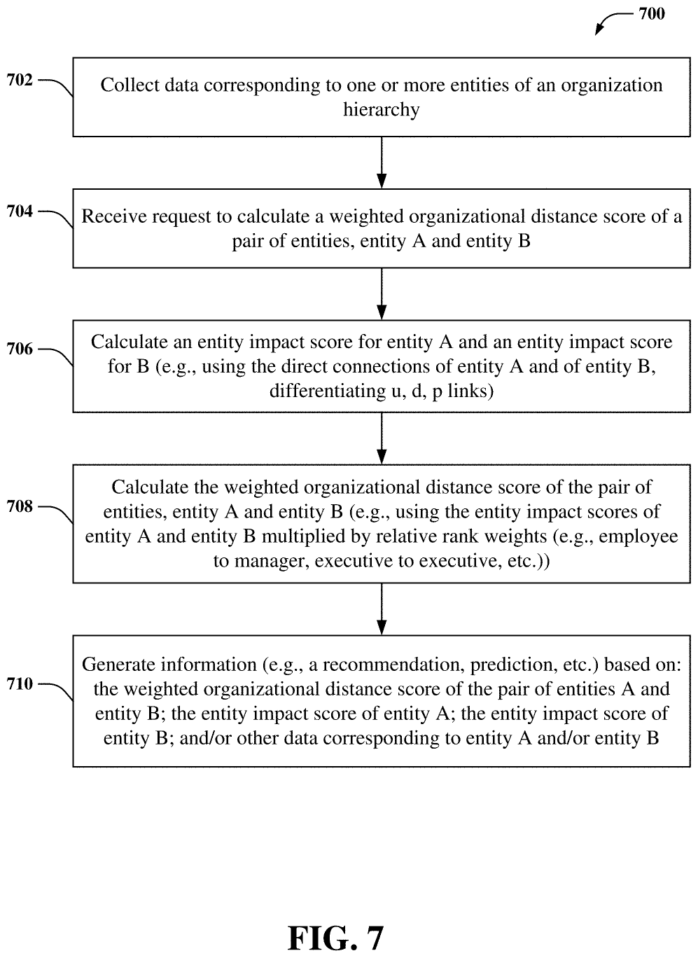

FIG. 7 illustrates a flow diagram of an example, non-limiting computer-implemented method 700 that can facilitate calculating an online social network distance between entities of an organization in accordance with one or more embodiments described herein. Repetitive description of like elements and/or processes employed in respective embodiments is omitted for sake of brevity.

In some embodiments, at 702, computer-implemented method 700 can comprise collecting (e.g., via weighted organizational distance system 102 and/or data collection component 602) data corresponding to one or more entities of an organization hierarchy. For example, as described above with reference to FIGS. 5 and 6, data collection component 602 can collect such data, which can include, but is not limited to: metadata; organizational rank; reporting chain; direct connection to one or more other entities of the organization hierarchy; an entity impact score of a directly connected entity of the organization hierarchy; online community activity; and/or other data.

In some embodiments, at 704, computer-implemented method 700 can comprise receiving (e.g., via weighted organizational distance system 102, an API, a GUI, etc.) a request to calculate a weighted organizational distance score of a pair of entities, entity A and entity B. For example, as described above, weighted organizational distance system 102 can comprise an interface component (e.g., an API and/or a GUI not illustrated in the figures) that can enable weighted organizational distance system 102 to receive such a request to calculate a weighted organizational distance score of a pair of entities (e.g., entity A and entity B of organization chart 200a illustrated in FIG. 2).

In some embodiments, at 706, computer-implemented method 700 can comprise calculating an entity impact score (e.g., via weighted organizational distance system 102, link weight component 402, and/or entity impact component 502) for entity A and an entity impact score for B (e.g., using the direct connections of entity A and of entity B, differentiating u, d, p links). For example, as described above with reference to FIG. 5, entity impact component 502 can calculate an entity impact score of an entity of an organization hierarchy (e.g., entity A and entity B of organization chart 200a illustrated in FIG. 2) by calculating a direct connection score of each of such entities, where such direct connection scores of entity A and entity B can respectively account for the direct connections of each entity.

In some embodiments, at 708, computer-implemented method 700 can comprise calculating (e.g., via weighted organizational distance system 102, weighted organizational distance component 108, link weight component 402, and/or entity impact component 502) the weighted organizational distance score of the pair of entities, entity A and entity B (e.g., using the entity impact scores of entity A and entity B multiplied by relative rank weights (e.g., person associated with the organization to manager, executive to executive, etc.)). For example, as described above with reference to FIG. 5, weighted organizational distance component 108 can calculate a weighted organizational distance score of one or more links and/or one or more weighted links between entities of an organization hierarchy (e.g., entity A and entity B of organization chart 200a illustrated in FIG. 2) based on an entity impact score of at least one of the entities. In this example, such an entity impact score can be calculated by entity impact component 502 based on a rank score of such an entity (e.g., entity A and entity B of organization chart 200a illustrated in FIG. 2) that can also be calculated by entity impact component 502 based on the entity's organizational ranking (e.g., the organizational rankings of entity A and entity B of organization chart 200a illustrated in FIG. 2).

In some embodiments, at 710, computer-implemented method 700 can comprise generating (e.g., via weighted organizational distance system 102 and/or learner component 110) information (e.g., a recommendation, prediction, etc.) based on: the weighted organizational distance score of the pair of entities A and entity B; the entity impact score of entity A; the entity impact score of entity B; and/or other data corresponding to entity A and/or entity B. For example, as described above with reference to FIG. 1, learner component 110 can comprise and/or employ an AI model to generate information based on one or more of the weighted organizational distance scores that can be calculated by weighted organizational distance component 108 as described herein, where such information can include, but is not limited to, an entity to entity connection recommendation, an entity assignment to a team recommendation, a team of defined entities recommendation, a team performance prediction, and/or other information. In this example, learner component 110 can facilitate generating information based on one or more of the weighted organizational distance scores that can be calculated by weighted organizational distance component 108 as described herein, where such weighted organizational distance scores can be calculated based on the respective entity impact scores of entity A and entity B of organization chart 200a and/or other data (e.g., the data, attributes, and/or actions defined above with reference to FIG. 5) corresponding to entity A and/or entity B.

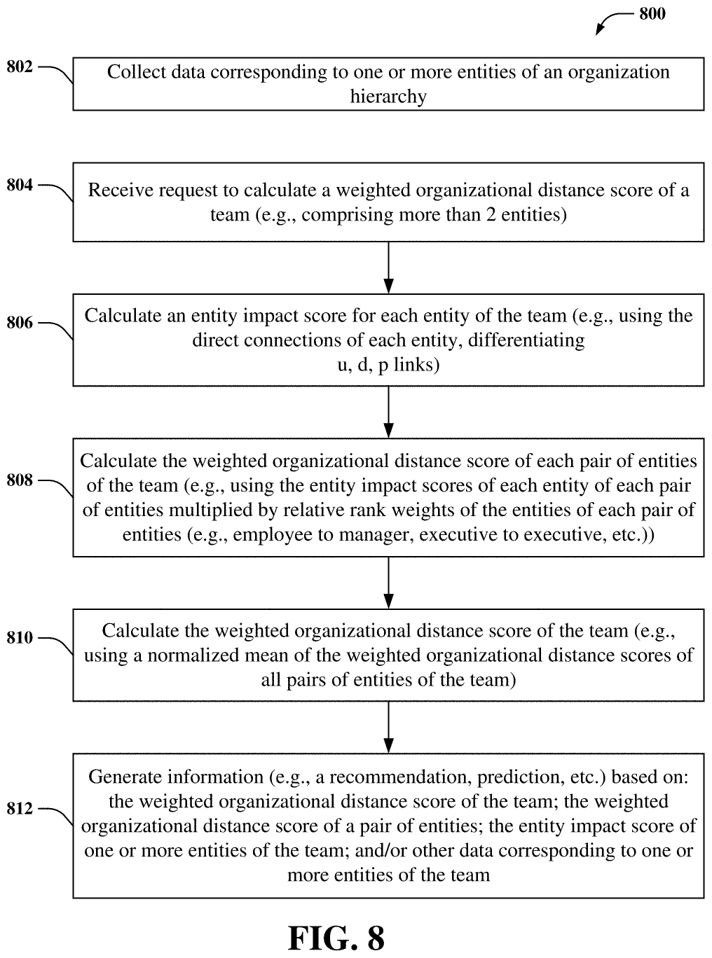

FIG. 8 illustrates a flow diagram of an example, non-limiting computer-implemented method 800 that can facilitate calculating an online social network distance between entities of an organization in accordance with one or more embodiments described herein. Repetitive description of like elements and/or processes employed in respective embodiments is omitted for sake of brevity.

In some embodiments, at 802, computer-implemented method 800 can comprise collecting (e.g., via weighted organizational distance system 102 and/or data collection component 602) data corresponding to one or more entities of an organization hierarchy. For example, as described above with reference to FIGS. 5 and 6, data collection component 602 can collect such data, which can include, but is not limited to: metadata; organizational rank; reporting chain; direct connection to one or more other entities of the organization hierarchy; an entity impact score of a directly connected entity of the organization hierarchy; online community activity; and/or other data.

In some embodiments, at 804, computer-implemented method 800 can comprise receiving (e.g., via weighted organizational distance system 102, an API, a GUI, etc.) a request to calculate a weighted organizational distance score of a team (e.g., comprising more than 2 entities). For example, as described above, weighted organizational distance system 102 can comprise an interface component (e.g., an API and/or a GUI not illustrated in the figures) that can enable weighted organizational distance system 102 to receive such a request to calculate a weighted organizational distance score of a team (e.g., of Project Team 1 represented by organization chart 200b illustrated in FIG. 2).

In some embodiments, at 806, computer-implemented method 800 can comprise calculating an entity impact score (e.g., via weighted organizational distance system 102, link weight component 402, and/or entity impact component 502) for each entity of the team (e.g., using the direct connections of each entity, differentiating u, d, p links). For example, as described above with reference to FIG. 5, entity impact component 502 can calculate an entity impact score of one or more entities of an organization hierarchy by calculating a direct connection score of each of such entities, where such direct connection score of each entity can respectively account for the direct connections of one or more other entities.

In some embodiments, at 808, computer-implemented method 800 can comprise calculating the weighted organizational distance score of each pair of entities of the team (e.g., using the entity impact scores of each entity of each pair of entities multiplied by relative rank weights of the entities of each pair of entities (e.g., person associated with the organization to manager, executive to executive, etc.)). For example, as described above, weighted organizational distance component 108 can calculate a weighted organizational distance score of a team of entities represented by an organization hierarchy by calculating the weighted organizational distance scores of one or more links between each possible pair combination of the entities in the team. In this example, as described above, weighted organizational distance component 108 can calculate the weighted organizational distance scores of one or more links between each possible pair combination of the entities in the team based on entity impact scores of each entity that can be calculated by entity impact component 502 (e.g., as described above with reference to FIG. 5). In this example, entity impact component 502 can further calculate a rank score of each entity of each possible pair combination of the entities in the team based on each entity's organizational ranking. For instance, as described above and based on such entity impact scores of each entity (e.g., as calculated by entity impact component 502), weighted organizational distance component 108 can calculate a weighted organizational distance score of Project Team 1 represented by organization chart 200b by calculating the weighted organizational distance scores of one or more links between each possible pair combination of entities D, H, E, I. In this example, as described above, weighted organizational distance component 108 can calculate a weighted organizational distance score of Project Team 1 represented by organization chart 200b by calculating the weighted organizational distance scores of: the link between entity D and entity H; the link between entity D and entity E; the link between entity D and entity I; the link between entity H and entity E; the link between entity H and entity I; and the link between entity E and entity I.

In some embodiments, at 810, computer-implemented method 800 can comprise calculating (e.g., weighted organizational distance system 102 and/or weighted organizational distance component 108) the weighted organizational distance score of the team (e.g., using a normalized mean of the weighted organizational distance scores of all pairs of entities of the team). For example, as described above, weighted organizational distance component 108 can calculate a weighted organizational distance score of Project Team 1 represented by organization chart 200b by calculating a normalized mean (e.g., an average) of the weighted organizational distance scores (e.g., calculated as described above) of the links between each pair of entities in Project Team 1 (e.g., as defined above).

In some embodiments, at 812, computer-implemented method 800 can comprise generating (e.g., via weighted organizational distance system 102 and/or learner component 110) information (e.g., a recommendation, prediction, etc.) based on: the weighted organizational distance score of the team; the weighted organizational distance score of a pair of entities; the entity impact score of one or more entities of the team; and/or other data corresponding to one or more entities of the team. For example, as described above with reference to FIG. 1, learner component 110 can comprise and/or employ an AI model to generate information based on one or more of the weighted organizational distance scores (e.g., weighted organizational distance scores of each pair of entities of Project Team 1 represented by organization chart 200b) that can be calculated by weighted organizational distance component 108 as described herein, where such information can include, but is not limited to, an entity to entity connection recommendation, an entity assignment to a team recommendation, a team of defined entities recommendation, a team performance prediction, and/or other information. In this example, learner component 110 can facilitate generating information based on one or more of the weighted organizational distance scores that can be calculated by weighted organizational distance component 108 as described herein, where such weighted organizational distance scores can be calculated based on the respective entity impact scores of each entity of Project Team 1 represented by organization chart 200b and/or other data (e.g., the data, attributes, and/or actions defined above with reference to FIG. 5) corresponding to one or more of such entities of Project Team 1.

In some embodiments, weighted organizational distance system 102 can be associated with various technologies. For example, weighted organizational distance system 102 can be associated with online social network technologies, social network distance calculation technologies, organizational distance calculation technologies, data analytics technologies, graph analytics technologies, artificial intelligence technologies, machine learning technologies, information retrieval technologies, information extraction technologies, computer technologies, server technologies, information technology (IT) technologies, internet-of-things (IoT) technologies, automation technologies, and/or other technologies.

In some embodiments, weighted organizational distance system 102 can provide technical improvements to systems, devices, components, operational steps, and/or processing steps associated with the various technologies identified above. For example, weighted organizational distance system 102 can: calculate a weighted organizational distance score of one or more links and/or one or more weighted links between entities of an organization hierarchy based on directionality of the one or more links relative to the organization hierarchy; and/or employing an artificial intelligence model to generate information based on the weighted organizational distance score.

In the example described above, by calculating such weighted organizational distance scores of one or more links that can be weighted based on directionality of the one or more links relative to the organization hierarchy, weighted organizational distance system 102 can provide technical improvements and/or an advantages over existing technologies, as such directionally weighted links enable weighted organizational distance system 102 to calculate a weighted organization distance score for each entity of an entity pair, thereby facilitating improved granularity in modeling a social network distance between the entities of the entity pair, where such social network distance defines a relationship between such entities of the entity pair. In this example, as the accuracy of such social network distance modeling is a key variable in the accuracy of a recommendation algorithm built upon it, by calculating such a weighted organizational distance score based on directionally weighted links between entities of an organization hierarchy, weighted organizational distance system 102 can thereby improve the accuracy of a recommendation component (e.g., learner component 110) that uses such a weighted organizational distance score calculated by weighted organizational distance system 102.

In some embodiments, weighted organizational distance system 102 can provide technical improvements to a processing unit (e.g., processor 106) associated with a classical computing device and/or a quantum computing device (e.g., a quantum processor, quantum hardware, superconducting circuit, etc.). For example, by improving the accuracy of a recommendation component (e.g., learner component 110) that uses a weighted organizational distance score calculated by weighted organizational distance system 102, weighted organizational distance system 102 can thereby improve processing performance of a processing unit (e.g., processor 106) associated with weighted organizational distance system 102. For instance, by improving the accuracy of a recommendation component (e.g., learner component 110) that uses a weighted organizational distance score calculated by weighted organizational distance system 102, weighted organizational distance system 102 can thereby facilitate reduced processing cycles needed to enable such a recommendation component (e.g., learner component 110) to generate accurate information based on such a weighted organizational distance score calculated by weighted organizational distance system 102.

In some embodiments, weighted organizational distance system 102 can employ hardware or software to solve problems that are highly technical in nature, that are not abstract and that cannot be performed as a set of mental acts by a human. In some embodiments, some of the processes described herein may be performed by one or more specialized computers (e.g., one or more specialized processing units, a specialized quantum computer, etc.) for carrying out defined tasks related to the various technologies identified above. In some embodiments, weighted organizational distance system 102 and/or components thereof, can be employed to solve new problems that arise through advancements in technologies mentioned above, employment of quantum computing systems, cloud computing systems, computer architecture, and/or another technology.

It is to be appreciated that weighted organizational distance system 102 can utilize various combinations of electrical components, mechanical components, and circuitry that cannot be replicated in the mind of a human or performed by a human, as the various operations that can be executed by weighted organizational distance system 102 and/or components thereof as described herein are operations that are greater than the capability of a human mind. For instance, the amount of data processed, the speed of processing such data, or the types of data processed by weighted organizational distance system 102 over a certain period of time can be greater, faster, or different than the amount, speed, or data type that can be processed by a human mind over the same period of time.

According to several embodiments, weighted organizational distance system 102 can also be fully operational towards performing one or more other functions (e.g., fully powered on, fully executed, etc.) while also performing the various operations described herein. It should be appreciated that such simultaneous multi-operational execution is beyond the capability of a human mind. It should also be appreciated that weighted organizational distance system 102 can include information that is impossible to obtain manually by an entity, such as a human user. For example, the type, amount, or variety of information included in weighted organizational distance system 102, weighted organizational distance component 108, learner component 110, link weight component 402, entity impact component 502, and/or data collection component 602 can be more complex than information obtained manually by a human user.

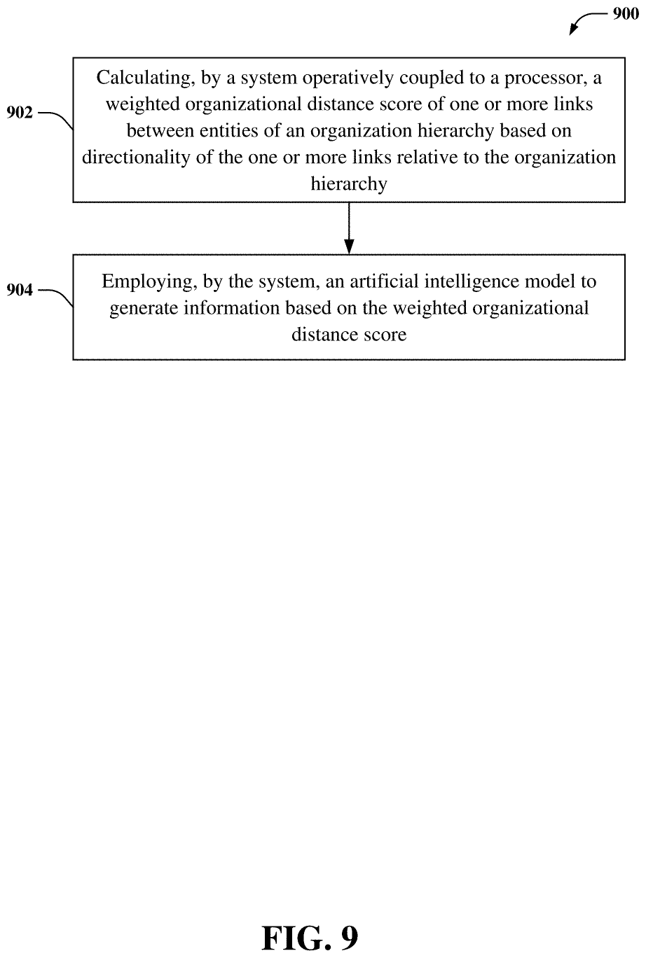

FIG. 9 illustrates a flow diagram of an example, non-limiting computer-implemented method 900 that can facilitate calculating an online social network distance between entities of an organization in accordance with one or more embodiments described herein. Repetitive description of like elements and/or processes employed in respective embodiments is omitted for sake of brevity.

In some embodiments, at 902, computer-implemented method 900 can comprise calculating, by a system (e.g., via weighted organizational distance system 102, weighted organizational distance component 108, link weight component 402, and/or entity impact component 502) operatively coupled to a processor (e.g., processor 106), a weighted organizational distance score of one or more links (e.g., discrete links or steps as defined above) between entities of an organization hierarchy (e.g., entities A, B, C, D, E, G, H, I, J, K, L of organization chart 200a) based on directionality (e.g., up (u), down (d), lateral (p), etc.) of the one or more links relative to the organization hierarchy.

In some embodiments, at 904, computer-implemented method 900 can comprise employing, by the system (e.g., via weighted organizational distance system 102 and/or learner component 110), an artificial intelligence model to generate information (e.g., a recommendation, a prediction, etc.) based on the weighted organizational distance score.

For simplicity of explanation, the computer-implemented methodologies are depicted and described as a series of acts. It is to be understood and appreciated that the subject innovation is not limited by the acts illustrated or by the order of acts, for example acts can occur in various orders or concurrently, and with other acts not presented and described herein. Furthermore, not all illustrated acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

In order to provide a context for the various aspects of the disclosed subject matter, FIG. 10 as well as the following discussion are intended to provide a general description of a suitable environment in which the various aspects of the disclosed subject matter can be implemented. FIG. 10 illustrates a block diagram of an example, non-limiting operating environment in which one or more embodiments described herein can be facilitated. Repetitive description of like elements and/or processes employed in other embodiments described herein is omitted for sake of brevity.

With reference to FIG. 10, a suitable operating environment 1000 for implementing various aspects of this disclosure can also include a computer 1012. The computer 1012 can also include a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014. The system bus 1018 can be any of several types of bus structure(s) including the memory bus or memory controller, a peripheral bus or external bus, or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 1016 can also include volatile memory 1020 and nonvolatile memory 1022. The basic input/output system (BIOS), containing the basic routines to transfer information between elements within the computer 1012, such as during start-up, is stored in nonvolatile memory 1022. Computer 1012 can also include removable/non-removable, volatile/non-volatile computer storage media. FIG. 10 illustrates, for example, a disk storage 1024. Disk storage 1024 can also include, but is not limited to, devices like a magnetic disk drive, floppy disk drive, tape drive, Jaz drive, Zip drive, LS-100 drive, flash memory card, or memory stick. The disk storage 1024 also can include storage media separately or in combination with other storage media. To facilitate connection of the disk storage 1024 to the system bus 1018, a removable or non-removable interface is typically used, such as interface 1026. FIG. 10 also depicts software that acts as an intermediary between users and the basic computer resources described in the suitable operating environment 1000. Such software can also include, for example, an operating system 1028. Operating system 1028, which can be stored on disk storage 1024, acts to control and allocate resources of the computer 1012.

System applications 1030 take advantage of the management of resources by operating system 1028 through program modules 1032 and program data 1034, e.g., stored either in system memory 1016 or on disk storage 1024. It is to be appreciated that this disclosure can be implemented with various operating systems or combinations of operating systems. A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port can be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices or systems of devices provide both input and output capabilities such as remote computer(s) 1044.

Computer 1012 can operate in a networked environment using logical connections to one or more remote computers, such as remote computer(s) 1044. The remote computer(s) 1044 can be a computer, a server, a router, a network PC, a workstation, a microprocessor based appliance, a peer device or other common network node and the like, and typically can also include many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1050 refers to the hardware/software employed to connect the network interface 1048 to the system bus 1018. While communication connection 1050 is shown for illustrative clarity inside computer 1012, it can also be external to computer 1012. The hardware/software for connection to the network interface 1048 can also include, for exemplary purposes only, internal and external technologies such as, modems including regular telephone grade modems, cable modems and DSL modems, ISDN adapters, and Ethernet cards.

Referring now to FIG. 11, an illustrative cloud computing environment 1150 is depicted. As shown, cloud computing environment 1150 includes one or more cloud computing nodes 1110 with which local computing devices used by cloud consumers, such as, for example, personal digital assistant (PDA) or cellular telephone 1154A, desktop computer 1154B, laptop computer 1154C, and/or automobile computer system 1154N may communicate. Nodes 1110 may communicate with one another. They may be grouped (not shown) physically or virtually, in one or more networks, such as Private, Community, Public, or Hybrid clouds as described hereinabove, or a combination thereof. This allows cloud computing environment 1150 to offer infrastructure, platforms and/or software as services for which a cloud consumer does not need to maintain resources on a local computing device. It is understood that the types of computing devices 1154A-N shown in FIG. 11 are intended to be illustrative only and that computing nodes 1110 and cloud computing environment 1150 can communicate with any type of computerized device over any type of network and/or network addressable connection (e.g., using a web browser).

Referring now to FIG. 12, a set of functional abstraction layers provided by cloud computing environment 1150 (FIG. 11) is shown. It should be understood in advance that the components, layers, and functions shown in FIG. 12 are intended to be illustrative only and embodiments of the invention are not limited thereto. As depicted, the following layers and corresponding functions are provided:

Hardware and software layer 1260 includes hardware and software components. Examples of hardware components include: mainframes 1261; RISC (Reduced Instruction Set Computer) architecture based servers 1262; servers 1263; blade servers 1264; storage devices 1265; and networks and networking components 1266. In some embodiments, software components include network application server software 1267 and database software 1268.

Virtualization layer 1270 provides an abstraction layer from which the following examples of virtual entities may be provided: virtual servers 1271; virtual storage 1272; virtual networks 1273, including virtual private networks; virtual applications and operating systems 1274; and virtual clients 1275.

In one example, management layer 1280 may provide the functions described below. Resource provisioning 1281 provides dynamic procurement of computing resources and other resources that are utilized to perform tasks within the cloud computing environment. Metering and Pricing 1282 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1283 provides access to the cloud computing environment for consumers and system administrators. Service level management 1284 provides cloud computing resource allocation and management such that required service levels are met. Service Level Agreement (SLA) planning and fulfillment 1285 provide pre-arrangement for, and procurement of, cloud computing resources for which a future requirement is anticipated in accordance with an SLA.

Workloads layer 1290 provides examples of functionality for which the cloud computing environment may be utilized. Non-limiting examples of workloads and functions which may be provided from this layer include: mapping and navigation 1291; software development and lifecycle management 1292; virtual classroom education delivery 1293; data analytics processing 1294; transaction processing 1295; and elevator analytics software 1296.

The present invention may be a system, a method, an apparatus or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations or block diagrams of methods, apparatus (systems), and computer program products according to embodiments of the invention. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components; and
a processor that executes the computer executable components stored in the memory, wherein the computer executable components comprise:
a weighted organizational distance component that calculates a weighted organizational distance score of one or more links between entities of an organization hierarchy based on directionality of the one or more links relative to the organization hierarchy; and
a learner component that employs an artificial intelligence model to generate information based on the weighted organizational distance score.

2. The system of claim 1, wherein the directionality comprises at least one of an up direction, a down direction, or a lateral direction.

3. The system of claim 1, wherein the weighted organizational distance component calculates a weighted organizational distance score of one or more weighted links between the entities of the organization hierarchy.

4. The system of claim 1, wherein the computer executable components further comprise:
a link weight component that assigns one or more weights to the one or more links based on the directionality of the one or more links relative to the organization hierarchy.

5. The system of claim 1, wherein the weighted organizational distance component calculates a weighted organizational distance score of the one or more links or one or more weighted links between the entities of the organization hierarchy based on an entity impact score of at least one of the entities, thereby facilitating at least one of improved accuracy of the learner component or improved performance of the processor.

6. The system of claim 1, wherein the computer executable components further comprise:
an entity impact component that calculates an entity impact score of at least one of the entities based on data selected from a group consisting of metadata, organizational rank, reporting chain, direct connection to one or more of the entities, a second entity impact score of a directly connected entity of the organization hierarchy, and online community activity.

7. The system of claim 1, wherein the computer executable components further comprise:
a data collection component that collects data corresponding to at least one of the entities.

8. The system of claim 1, wherein the information comprises at least one of an entity to entity connection recommendation, an entity assignment to a team recommendation, a team of defined entities recommendation, or a team performance prediction.

9. A computer-implemented method, comprising:
calculating, by a system operatively coupled to a processor, a weighted organizational distance score of one or more links between entities of an organization hierarchy based on directionality of the one or more links relative to the organization hierarchy; and
employing, by the system, an artificial intelligence model to generate information based on the weighted organizational distance score.

10. The computer-implemented method of claim 9, wherein the calculating comprises:
calculating, by the system, a weighted organizational distance score of one or more weighted links between the entities of the organization hierarchy.

11. The computer-implemented method of claim 9, further comprising:
assigning, by the system, one or more weights to the one or more links based on the directionality of the one or more links relative to the organization hierarchy.

12. The computer-implemented method of claim 9, further comprising:
calculating, by the system, a weighted organizational distance score of the one or more links or one or more weighted links between the entities of the organization hierarchy based on an entity impact score of at least one of the entities, thereby facilitating at least one of improved accuracy of a learner component of the system or improved performance of the processor.

13. The computer-implemented method of claim 9, further comprising:
calculating, by the system, an entity impact score of at least one of the entities based on data selected from a group consisting of metadata, organizational rank, reporting chain, direct connection to one or more of the entities, a second entity impact score of a directly connected entity of the organization hierarchy, and online community activity.

14. The computer-implemented method of claim 9, wherein the employing comprises:
employing, by the system, the artificial intelligence model to generate at least one of an entity to entity connection recommendation, an entity assignment to a team recommendation, a team of defined entities recommendation, or a team performance prediction based on the weighted organizational distance score.

15. A computer program product facilitating calculation of an online social network distance between entities of an organization, the computer program product comprising a computer readable storage medium having program instructions embodied therewith, the program instructions executable by a processor to cause the processor to:
calculate, by the processor, a weighted organizational distance score of one or more links between entities of an organization hierarchy based on directionality of the one or more links relative to the organization hierarchy; and
employ, by the processor, an artificial intelligence model to generate information based on the weighted organizational distance score.

16. The computer program product of claim 15, wherein the program instructions are further executable by the processor to cause the processor to:
calculate, by the processor, a weighted organizational distance score of one or more weighted links between the entities of the organization hierarchy.

17. The computer program product of claim 15, wherein the program instructions are further executable by the processor to cause the processor to:
assign, by the processor, one or more weights to the one or more links based on the directionality of the one or more links relative to the organization hierarchy.

18. The computer program product of claim 15, wherein the program instructions are further executable by the processor to cause the processor to:
calculate, by the processor, a weighted organizational distance score of the one or more links or one or more weighted links between the entities of the organization hierarchy based on an entity impact score of at least one of the entities.

19. The computer program product of claim 15, wherein the program instructions are further executable by the processor to cause the processor to:
calculate, by the processor, an entity impact score of at least one of the entities based on data selected from a group consisting of metadata, organizational rank, reporting chain, direct connection to one or more of the entities, a second entity impact score of a directly connected entity of the organization hierarchy, and online community activity.

20. The computer program product of claim 15, wherein the program instructions are further executable by the processor to cause the processor to:
employ, by the processor, the artificial intelligence model to generate at least one of an entity to entity connection recommendation, an entity assignment to a team recommendation, a team of defined entities recommendation, or a team performance prediction based on the weighted organizational distance score.
